(19) United States
(12) Patent Application Publication
(10) Pub. No.: US 2022/0395025 A1
(43) Pub. Date: Dec. 15, 2022

(54) Consumable for an Aerosol Generating Device, Method and System for Manufacturing a Consumable

(71) Applicant: JT International S.A., Geneva (CH)

(72) Inventor: Andrew Robert John Rogan, Forres (GB)

(73) Assignee: JT International S.A., Geneva (CH)

(21) Appl. No.: 17/772,629

(22) PCT Filed: Oct. 29, 2020
(86) PCT No.: PCT/EP2020/080457

§ 371 Date: Apr. 28, 2022

(30) Foreign Application Priority Data
Oct. 29, 2019 (EP) 19206025.9

(51) Int. Cl. A24F 40/465; A24F 40/70

(52) U.S. Cl. CPC A24F 40/465; A24F 40/70

(57) ABSTRACT

A consumable for an aerosol generating device, comprising: a heating element comprising a base portion and a plurality of elongate portions extending from the base portion; and a columnar portion of aerosol generation substrate, the columnar portion being formed from a strip of aerosol generation substrate, wherein an axial portion of the strip extends through a gap between a pair of the elongate portions of the heating element, and the strip is wound around the heating element.

### TECHNICAL FIELD

The present disclosure relates to consumables for aerosol generation devices. The consumable may comprise tobacco or other suitable aerosol substrate materials to be heated, rather than burned, to generate an aerosol for inhalation.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate that typically comprises moist leaf tobacco or other suitable aerosolisable material to a temperature typically in the range 150° C. to 300° C. Heating an aerosol substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

It is desirable to provide a consumable that can generate an aerosol with improved energy efficiency and that can be simply manufactured.

### SUMMARY

According to a first aspect, the present disclosure provides a consumable for an aerosol generating device, comprising: a heating element comprising a base portion and a plurality of elongate portions extending from the base portion; and a columnar portion of aerosol generation substrate, the columnar portion being formed from a strip of aerosol generation substrate, wherein an axial portion of the strip extends through a gap between a pair of the elongate portions of the heating element, and the strip is wound around the heating element.

Optionally, the axial portion is an end of the strip.

Optionally, the pair of the elongate portions of the heating element are arranged to hold the axial portion by applying pressure to the axial portion.

Optionally, the heating element is an inductive heating element.

Optionally, the plurality of elongate portions extend from the base portion by more than half of a length of the columnar portion.

Optionally, the aerosol generation substrate comprises reconstituted tobacco.

Optionally, the consumable comprises packaging enclosing the heating element and the columnar portion of aerosol generation substrate.

According to a second aspect, the present disclosure provides a method for manufacturing a consumable as described above, the method comprising: holding the heating element in a clamp; arranging the axial portion of the strip of aerosol generation substrate between the pair of the elongate portions of the heating element; rotating the heating element and/or the strip of aerosol generation substrate around the axial portion, to wind the strip of aerosol generation substrate around the heating element and form the columnar portion; and releasing the consumable, comprising the heating element and the columnar portion, from the clamp.

Optionally, the method comprises holding the axial portion in the clamp.

Optionally, the clamp is configured to hold the axial portion by applying pressure to the pair of elongate portions of the heating element.

Optionally, the clamp is a chuck and rotating the heating element around the axial portion comprises rotating the chuck.

Optionally, the method comprises forming the heating element by bending and cutting a wire.

Optionally, the strip is part of continuous ribbon of aerosol generation substrate, and the method comprises cutting the ribbon after the rotating.

Optionally, the method comprises driving an exposed part of the heating element into the columnar portion after the rotating.

According to a third aspect, the present disclosure provides a system for manufacturing a consumable as described above, the system comprising: a clamp adapted to hold the heating element; a feeder arranged to feed the strip of aerosol generation substrate to arrange the axial portion of the strip between the pair of the elongate portions of the heating element; a rotor configured to rotate the clamp and/or the feeder around the axial portion, to wind the strip of aerosol generation substrate around the heating element and form the columnar portion, wherein the clamp is configured to release the consumable, comprising the heating element and the columnar portion, after formation of the columnar portion.

Optionally, the system comprises a punch configured to form the heating element by bending and cutting a wire.

### BRIEF DESCRIPTION OF THE DRAWINGS

FIG. 1A is a schematic illustration of a consumable according to the invention;

FIG. 1B is a schematic illustration of a heating element;

FIG. 1C is a schematic illustration of an end of the consumable;

FIGS. 2A to 2E are schematic illustrations of a method of manufacturing the consumable;

FIGS. 3A and 3B are schematic illustrations of a consumable in use in examples of an aerosol generating device.

### DETAILED DESCRIPTION

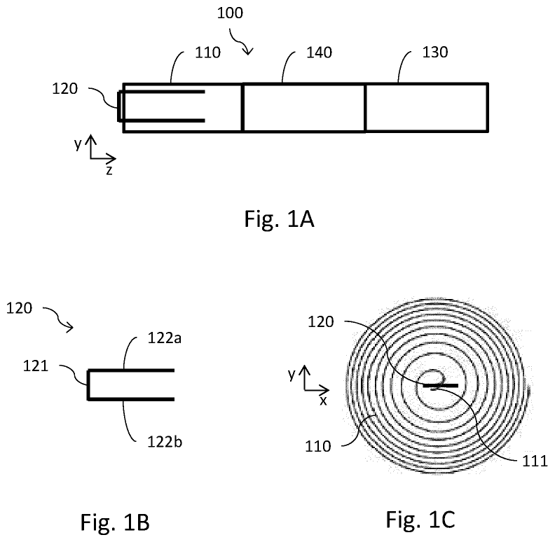

FIG. 1A schematically illustrates a consumable according to an embodiment of the invention.

Referring to FIG. 1A, the consumable 100 comprises a heating element 120. The consumable 100 further comprises a columnar portion 110 of aerosol generation substrate.

In many examples, consumables for aerosol generation devices are relatively long in one direction (labelled in FIG. 1A as the z direction) with a relatively small cross-section perpendicular to the ‘long’ direction. In such consumables, a ‘columnar’ portion refers to a portion extending along the ‘long’ direction.

Although reference to such consumables is convenient for explaining the invention, the invention is equally applicable to consumables where no such ‘long’ direction may be discerned, in which case the ‘columnar’ portion may be any portion of aerosol generation substrate.

The heating element 120 may, for example, be an inductive heating element (also called a susceptor) that is configured to receive energy via electromagnetic induction and dissipate the received energy to perform heating. Alternatively, the heating element 120 may be a conductive heating element configured to receive energy via an electric current. The heating element may typically comprise an electrically conductive material, including a metallic material such as aluminium, iron, alloy steel, copper, etc., and/or a non-metallic material such as graphite, silicon carbide, etc.

Detail of a first example of a heating element 120 is shown in FIG. 1B.

As shown in FIG. 1B, the heating element 120 comprises a base portion 121 and a plurality of elongate portions 122a, 122b extending from the base portion 120. When embedded in the columnar portion 110, the elongate portions are arranged to extend along the columnar portion. That is, the elongate portions are arranged to extend along the ‘long’ direction of the columnar portion.

With this arrangement of the elongate portions, an inductive heating element may conveniently be powered by surrounding the columnar portion with a solenoid. With such an arrangement, the magnetic field of the solenoid can be parallel to the elongate portions, inducing currents around their surface area. Furthermore, even if the heating element is not an inductive heating element, arranging the elongate portions along the columnar portion improves the uniformity of heating of the aerosol substrate.

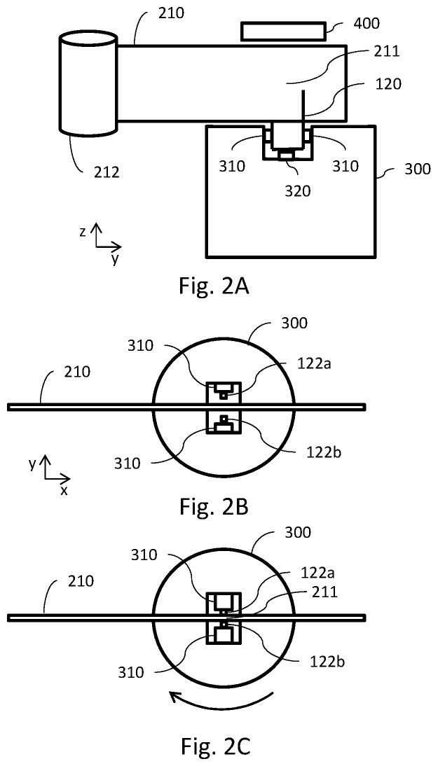

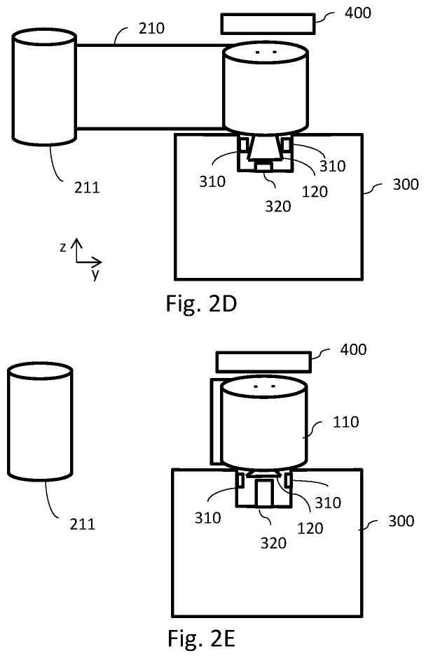

This arrangement of a base portion and a plurality of elongate portions also means that the heating element is adapted to be driven towards the columnar portion 110 via a force applied to the base portion 121 (as shown in FIG. 2E, described later). In particular, the base portion 121 provides a surface for driving, while the elongate portions 122a, 122b are arranged to penetrate through the columnar portion 110 with lower resistance than the base portion 121.

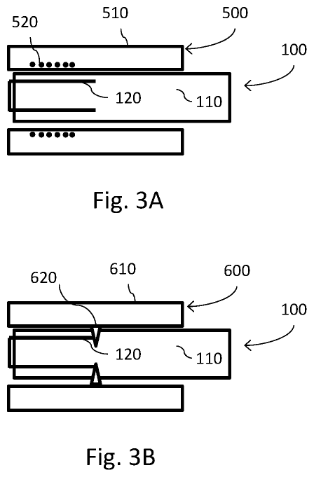

The plurality of elongate portions 122a, 122b may extend from the base portion 121 a large proportion of a length of the columnar portion 110. As described later with reference to FIG. 3, the elongate portions may participate in the heating by the heating element. As a result, the further the elongate portions extend into the columnar portion, the more uniformly the columnar portion 110 is heated. The elongate portions 122a, 122b may, for example, extend from the base portion 121 by more than half of the length of the columnar portion 110.

In the example of FIG. 1B, the heating element 120 has two elongate portions 122a, 122b, which are arranged at respective ends of the base portion 121 to form a U-shape. Using at least two elongate portions spread as far apart as possible along the base portion has the effect of stabilising the heating element 120 as it is driven into the columnar portion 110, and increasing the number of elongate portions 122 increases the amount of material required for the heating element 120. Therefore, a U-shape balances the requirements of stability when driving the heating element and reducing the amount of material required for the heating element.

The heating element 120 may advantageously have a substantially similar cross-section throughout the base portion and the plurality of elongate portions. This simplifies the manufacture of the heating element 120 by enabling usage of a long material with substantially uniform cross-section to form the heating element. Additionally, the substantially similar cross-section of the base portion and elongate portions means that the current is substantially uniform on the surface of the elongate portions, and uniformity of the heat distribution from the heating element is increased.

More preferably, the heating element 120 may be formed from a wire that is bent to form the base portion and the plurality of elongate portions. Bending a wire avoids the need to attach any of the base portion and elongate portions together, thus further simplifying the manufacture of the heating element 120.

The columnar portion 110 is formed from a strip of aerosol generation substrate, wherein an axial portion of the strip extends through a gap between a pair of the elongate portions of the heating element, and the strip is wound around the heating element.

FIG. 1C is a rotated view of the consumable of FIG. 1A, from an end perspective where the z direction of FIG. 1A extends into the page. FIG. 1C illustrates the base portion 121 of the heating element 120 extending across the end of the columnar portion 110, while the elongate portions 122 (not shown) extend from the base portion into the columnar portion 110.

In FIG. 1C, it can be seen that the strip of aerosol generation substrate may be wound around the heating element in a spiral shape, and an axial portion 111 of the strip extends through the heating element 120. Although it is not shown in FIG. 1C, the axial portion 111 of the strip extends through a gap between a pair of the elongate portions 122 (not shown).

The axial portion 111 is a portion of the strip that is at or near to a central axis of the consumable 100. In the example shown in FIG. 1C, the axial portion 111 of the strip is the end of the strip. However, this is not necessary in other examples. For example, the strip may be wrapped around the heating element 120 as a double spiral, with the axial portion 111 being closer to a middle of the length of the strip of aerosol generation substrate.

In this example, the pair of elongate portions 122, between which the axial portion 111 of the strip extends, are arranged to hold the axial portion by applying pressure to the axial portion. As described in more detail below, this may be achieved by clamping the pair of elongate portions against the axial portion 111 in a method of manufacturing the consumable 100. However, in other embodiments, the axial portion 111 need not be held by the heating element 120. For example, in any embodiment, the consumable 100 may comprise packaging enclosing the heating element 120 and the columnar portion 110, which holds the strip of aerosol generation substrate in place around the heating element 120. Furthermore, the strip of aerosol generation substrate may be wrapped sufficiently tightly around the heating element 120 to hold the heating element in place even without the clamping or packaging.

The aerosol substrate may, for example, comprise a tobacco material in various forms such as shredded tobacco and granulated tobacco, and/or the tobacco material may comprise tobacco leaf and/or reconstituted tobacco.

Referring back to FIG. 1A, the consumable 100 may further comprise a tube section 140 between a filter 130 and the columnar portion 110. The tube section can be used to allow the generated aerosol to cool before it reaches a mouth end of the consumable. In such embodiments of the consumable 100, the packaging around the columnar portion 110 may be a wrapping around a side of the columnar portion along the long direction of the columnar portion, and the wrapping may extend to form the tube section 140, and may even extend to or around the filter 130.

The tube section 140 and/or the wrapping around the columnar portion 110 may, for example, comprise paper and/or other textile materials, and may also comprise various organic materials and/or inorganic materials.

Additionally, the base portion 121 is preferably arranged at an open end of the columnar portion 110. In a common consumable design, the consumable comprises a filter 130 at a mouth end of the consumable. In such a design, the open end is opposed to the mouth end.

More specifically, in FIG. 1A, the base portion 121 is close to but not actually embedded in the open end of the columnar portion 110, while the elongate portions are almost entirely embedded.

In other consumables, no filter is included with the consumable, and the ‘open end’ may be either end of the columnar portion.

FIGS. 2A to 2E schematically illustrate a method and system for manufacturing a consumable as described above.

FIGS. 2A and 2B are schematic illustrations of a side view and top view of a state of the system during an initial part of the method. The initial part of the method comprises holding a heating element 120 in a clamp 300, and arranging an axial portion 211 of a strip of aerosol generation substrate 210 between a pair of elongate portions 122a, 122b of the heating element.

In this embodiment, the strip of aerosol generation substrate 210 is fed by a feeder 212 to arrange the axial portion 211 between the pair of elongate portions of the heater element 120. The feeder may feed the strip from a long continuous reel of aerosol generation substrate.

In this embodiment, the clamp 300 is adapted to hold the heating element 120. More specifically, in this embodiment, the clamp 300 comprises clamping actuators 310 arranged to apply pressure to the pair of elongate portions 122a, 122b of the heating element 120. The clamping actuators 310 may be controlled such that, when a heating element 120 is inserted into the clamp 300, the clamping actuators 310 engage to hold the heating element 120, and when a heating element 120 is to be removed from the clamp 300, the clamping actuators 310 disengage.

Alternatively, the clamp 300 may be adapted to provide a tight fit for the heating element 120, such that the heating element 120 is held in place, and force must be applied to insert or remove the heating element 120. Furthermore, as shown in FIG. 2A, a movable guard 400 may be arranged in a first position to prevent the heating element 120 from leaving the clamp 300 unintentionally, and moved to a second position when inserting or removing the heating element 120.

FIG. 2C is a schematic illustration of the top view for a state of the system after the initial part of the method. More specifically, in this embodiment, the method further comprises holding the axial portion 211 in the clamp 300. This may, for example, be achieved by controlling the clamping actuators 310 to apply sufficient pressure to the pair of elongate portions 122a, 122b of the heating element 120 such that the elongate portions 122a, 122b bend and transmit pressure to the axial portion 211.

Alternatively, the clamp 300 may have a separate adaptation, such as further actuators, for holding the axial portion 211 directly. Furthermore, instead of the clamp 300 holding the axial portion 211, the strip of aerosol generation substrate 210 may be held under tension between two end points. For example, the strip 210 may be fed from the feeder 212 past the clamp 300 to a holding means opposite the feeder 212.

At this point in the method, the strip of aerosol generation substrate 210 is wound around the heating element 120 to form a columnar portion 110. This can be achieved by rotating the heating element 120 around the axial portion 211, or by rotating the strip 210 around the axial portion 211, or by performing both rotations at the same time (preferably in opposite directions). The method may also include a step of cutting off a part of the strip 210 which extends beyond the axial portion 211, beyond the gap between the pair of the elongate portions 122a, 122b, before the strip 210 is wound around the heating element 120. This means that the axial portion 211 of the strip 210 is formed as the end of the strip 210.

In one embodiment, the clamp 300 is a chuck, and the heating element 120 is rotated around the axial portion 211 by rotating the chuck. This may be achieved by including, in the system, a rotor configured to rotate the clamp 300 around the axial portion 211, to wind the strip of aerosol generation substrate around the heating element 120 and form the columnar portion.

In another embodiment, the system comprises a rotor configured to rotate the feeder 212 around the axial portion 211, to wind the strip of aerosol generation substrate around the heating element 120 and form the columnar portion.

FIG. 2D is a schematic illustration of the side view for a state of the system after the strip 210 is wound around the heating element 120.

In embodiments where the strip of aerosol generation substrate 210 is part of a continuous ribbon of aerosol generation substrate that can be used to form multiple consumables, the strip 210 remains held by the feeder 211. In such embodiments, the method comprises a further step of cutting the ribbon after forming the columnar portion 110, leaving the strip as shown in FIG. 2E.

Additionally, as shown in FIG. 2D, a part of the heating element 120 which has been held by the clamp 300 extends beyond the columnar portion 110 as an exposed part. The method may (independently from the cutting of the ribbon) further comprise driving the exposed part of the heating element 120 into the columnar portion after forming the columnar portion 110. This may, for example, be achieved by providing a driving actuator 320 in the clamp 300, wherein the driving actuator 320 is arranged to drive the heating element 120 into the columnar portion 110, as shown in FIG. 2E. However, the clamping actuators 310 in this embodiment do not hold the heating element 120 while the heating element is driven into the columnar portion. Instead, the guard 400 may be configured to act as a reaction surface to hold the columnar portion 110 in place while the heating element 120 is driven in.

After formation of the columnar portion, the method comprises releasing the consumable, comprising the heating element 120 and the columnar portion 110, from the clamp 300. In some embodiments, this may occur in two stages comprising releasing the clamping actuators 310 and moving the guard 400 to the second position. This allows for the above-mentioned driving to occur between releasing the clamping actuators 310 and moving the guard 400.

The system may further comprise a picker for removing the consumable, and/or a heating element placer for providing a new heating element 120 in the clamp 300 ready to manufacture a next consumable.

New heating elements 120 may be provided pre-formed with a base portion and a plurality of elongate portions. However, alternatively, the method may further comprise forming a heating element 120 from a wire. A portion of a long wire may be bent into the shape of the heating element 120 and cut to separate the heating element 120 from the remainder of the long wire. Correspondingly, the system may comprise a punch configured to form the heating element 120 by bending and cutting the wire. The punch may perform bending and cutting simultaneously to simplify formation of the heating element 120.

FIGS. 3A and 3B show examples of usage of a consumable as described above to generate an aerosol.

FIG. 3A schematically illustrates a consumable 100 in an aerosol generation device 500.

The aerosol generation device 500 comprises a heating chamber 510 comprising a driving element 520 configured to drive the heating element 120 of the consumable 100. In this example, the driving element 520 is a solenoid coil arranged to generate a magnetic field in the heating chamber 510. The magnetic field induces a current in the heating element 120 to perform heating of the columnar portion of aerosol substrate 110.

In order to generate an inhalable aerosol, a user may insert the consumable 100 into the heating chamber 510, and heat the columnar portion 110 using the heating element 120 to generate the inhalable aerosol.

In this example, the consumable 100 does not have a filter 130 or tube section 140. Such a simple consumable may, for example, be used in a case where the aerosol generation device itself has a mouthpiece and a filter (not shown) from which a user may obtain the generated aerosol. Additionally, depending on the content of the aerosol, a filter may be omitted in some embodiments.

FIG. 3B schematically illustrates a consumable 100 in a second aerosol generation device 600.

The aerosol generation device 600 also comprises a heating chamber 610 and a driving element 620. However, in this example, the driving element 620 comprises piercing elements arranged to penetrate the columnar portion 110 and make electrical contact with the heating element 120 in order to drive a current through the heating element. The driving element 620 may be retractable in order to allow a consumable to be added to and removed from the heating chamber 610. Alternatively the heating chamber 610 may comprise a cover portion that can be moved to open or close an opening through which the consumable 100 can be added or removed.

In order to generate an inhalable aerosol, a user may insert the consumable 100 into the heating chamber 610, and heat the columnar portion 110 using the heating element 120 to generate the inhalable aerosol.

1. A consumable for an aerosol generating device, comprising:
a heating element comprising a base portion and a plurality of elongate portions extending from the base portion; and
a columnar portion of aerosol generation substrate, the columnar portion being formed from a strip of aerosol generation substrate, wherein an axial portion of the strip extends through a gap between a pair of the elongate portions of the heating element, and the strip is wound around the heating element.

2. The consumable according to claim 1, wherein the axial portion is an end of the strip.

3. The consumable according to claim 1, wherein the pair of the elongate portions of the heating element are arranged to hold the axial portion by applying pressure to the axial portion.

4. The consumable according to claim 1, wherein the heating element is an inductive heating element.

5. The consumable according to claim 1, wherein the plurality of elongate portions extend from the base portion by more than half of a length of the columnar portion.

6. The consumable according to claim 1, wherein the aerosol generation substrate comprises reconstituted tobacco.

7. The consumable according to claim 1, further comprising packaging enclosing the heating element and the columnar portion of aerosol generation substrate.

8. A method for manufacturing a consumable for an aerosol generating device, the method comprising:
holding a heating element in a clamp;
arranging an axial portion of a strip of aerosol generation substrate between a pair of elongate portions of the heating element;
rotating the heating element and/or the strip of aerosol generation substrate around the axial portion, to wind the strip of aerosol generation substrate around the heating element and to form a columnar portion; and
releasing the consumable, comprising the heating element and the columnar portion, from the clamp.

9. The method according to claim 8, further comprising holding the axial portion in the clamp.

10. The method according to claim 9, wherein the clamp is configured to hold the axial portion by applying pressure to the pair of elongate portions of the heating element.

11. The method according to claim 8, wherein the clamp is a chuck and wherein rotating the heating element around the axial portion comprises rotating the chuck.

12. The method according to claim 8, comprising forming the heating element by bending and cutting a wire.

13. The method according to claim 8, wherein the strip is part of a continuous ribbon of aerosol generation substrate, and the method comprises cutting the ribbon after the rotating step.

14. The method according to claim 8, comprising driving an exposed part of the heating element into the columnar portion after the rotating step.

15. A system for manufacturing a consumable for an aerosol generating device, the system comprising:
a clamp adapted to hold a heating element;
a feeder arranged to feed a strip of aerosol generation substrate to arrange an axial portion of the strip between a pair of elongate portions of the heating element;
a rotor configured to rotate the clamp and/or the feeder around the axial portion, to wind the strip of aerosol generation substrate around the heating element and to form a columnar portion,
wherein the clamp is configured to release the consumable, comprising the heating element and the columnar portion, after formation of the columnar portion.

16. The system according to claim 15, further comprising a punch configured to form the heating element by bending and cutting a wire.
